(19) United States
(12) Patent Application Publication
(10) Pub. No.: US 2009/0094561 A1
(43) Pub. Date: Apr. 9, 2009

(54) Displaying Personalized Documents To Users Of A Surface Computer

(75) Inventors: Lydia M. Do, Raleigh, NC (US); Pamela A. Nesbitt, Tampa, FL (US); Lisa A. Seacat, San Francisco, CA (US)

Correspondence Address: INTERNATIONAL CORP (BLF), c/o BIGGERS & OHANIAN, LLP, P.O. BOX 1469, AUSTIN, TX, 78767-1469, US

(73) Assignee: INTERNATIONAL BUSINESS MACHINES CORPORATION, Armonk, NY (US)

(21) Appl. No.: 11/868,216

(22) Filed: Oct. 5, 2007

(51) Int. Cl. G06F 3/048

(52) U.S. Cl. 715/863

(57) ABSTRACT

Methods, apparatus, and products are disclosed for displaying personalized documents to users of a surface computer, the surface computer comprising a surface, surface computer capable receiving multi-touch input through the surface and rendering display output on the surface, that include: registering a plurality of users with the surface computer; assigning, to each registered user, a portion of the surface for interaction between that registered user and the surface computer; selecting a user profile for each registered user; creating, for each registered user from a content repository, personalized display content for that registered user in dependence upon the user profile selected for that registered user; and rendering the personalized display content for each registered user on that user's assigned portion of the surface.

### BACKGROUND OF THE INVENTION

1. Field of the Invention

The field of the invention is data processing, or, more specifically, methods, apparatus, and products for displaying personalized documents to users of a surface computer.

2. Description of Related Art

Multi-touch surface computing is an area of computing that has made tremendous advancements over the last few years. Multi-touch surface computing allows a user to interact with a computer through a surface that is typically implemented as a table top. The computer renders a graphical user interface (‘GUI’) on the surface and users may manipulate GUI objects directly with their hands using multi-touch technology as opposed to using traditional input devices such as a mouse or a keyboard. In such a manner, the devices through which users provide input and receive output are merged into a single surface, which provide an intuitive and efficient mechanism for users to interact with the computer. As surface computing becomes more ubiquitous in everyday environments, readers will appreciate advancements in how users may utilize surface computing to intuitively and efficiently perform tasks that may be cumbersome using traditional input devices such as a keyboard and mouse. Specifically, readers will appreciate advancements in displaying personalized documents to users of a surface computer.

### SUMMARY OF THE INVENTION

Methods, apparatus, and products are disclosed for displaying personalized documents to users of a surface computer, the surface computer comprising a surface, surface computer capable receiving multi-touch input through the surface and rendering display output on the surface, that include: registering a plurality of users with the surface computer; assigning, to each registered user, a portion of the surface for interaction between that registered user and the surface computer; selecting a user profile for each registered user; creating, for each registered user from a content repository, personalized display content for that registered user in dependence upon the user profile selected for that registered user; and rendering the personalized display content for each registered user on that user's assigned portion of the surface.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a functional block diagram of an exemplary surface computer capable of displaying personalized documents to users according to embodiments of the present invention.

FIG. 2A sets forth a line drawing illustrating an exemplary surface useful in displaying personalized documents to users of a surface computer according to embodiments of the present invention.

FIG. 2B sets forth a line drawing illustrating a further exemplary surface useful in displaying personalized documents to users of a surface computer according to embodiments of the present invention.

FIG. 3 sets forth a flow chart illustrating an exemplary method of displaying personalized documents to users of a surface computer according to embodiments of the present invention.

### DETAILED DESCRIPTION OF EXEMPLARY EMBODIMENTS

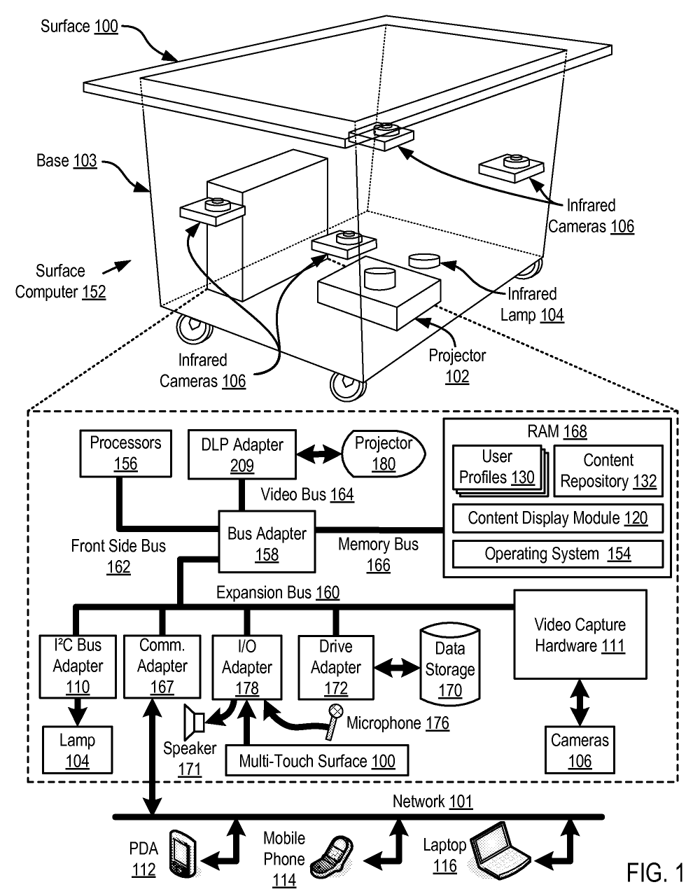

Exemplary methods, apparatus, and products for displaying personalized documents to users of a surface computer in accordance with the present invention are described with reference to the accompanying drawings, beginning with FIG. 1. FIG. 1 sets forth a functional block diagram of an exemplary surface computer (152) capable of displaying personalized documents to users according to embodiments of the present invention. The exemplary surface computer (152) of FIG. 1 includes a surface (100) mounted atop a base (103) that houses the other components of the surface computer (152). The surface (100) may be implemented using acrylic, glass, or other materials as will occur to those of skill in the art. In addition to the computing functionality provided by the surface computer (152), the surface (100) of FIG. 1 may also serve as a table top for a coffee table, dining table, a conference table, or some other table as will occur those of skill in the art. Examples of a surface computer that may be improved for displaying personalized documents to users according to embodiments of the present invention may include the Microsoft Surface™ and the ROSIE Coffee Table by Savant.

The exemplary surface computer (152) of FIG. 1 is capable of receiving multi-touch input through the surface (100) and rendering display output on the surface (100). Multi-touch input refers to the ability of the surface computer (152) to recognize multiple simultaneous points of contact between objects and the surface (100). These objects may include hands, fingers, portable electronic devices, papers, cups, plates, or any other object as will occur to those of skill in the art. Such recognition may include the position and pressure or degree of each point of contact, which allows gestures and interaction with multiple fingers or hands through intuitive gestures. Depending largely on the size of the surface, a surface computer typically supports interaction with more than one user or object simultaneously. In the example of FIG. 1, the surface computer (100) supports interaction with a plurality of users.

In the example of FIG. 1, the exemplary surface computer (152) receives multi-touch input through the surface (100) by reflecting infrared light off of objects on top of the surface (100) and capturing the reflected images of the objects using multiple infrared cameras (106) mounted inside the base (103). Using the reflected infrared images, the surface computer (100) may then perform pattern matching to determine the type of objects that the images represent. The objects may include fingers, hands, portable electronic devices, papers, and so on. The infrared light used to generate the images of the objects is provided by an infrared lamp (104) mounted to the base (103) of the surface computer (152). Readers will note that infrared light may be used to prevent any interference with users' ability to view the surface (100) because infrared light is typically not visible to the human eye.

Although the exemplary surface computer (152) of FIG. 1 above receives multi-touch input through the surface (100) using a system of infrared lamps and cameras, readers will note that such implementation are for explanation only and not for limitation. In fact, other embodiments of a surface computer for displaying documents to a plurality of users according to embodiments of the present invention may use other technologies as will occur to those of skill in the art such as, for example, frustrated total internal reflection. Frustrated total internal reflection refers to a technology that disperses light through a surface using internal reflection. When an object comes in contact with one side of the surface, the dispersed light inside the surface scatters onto light detectors on the opposite side of the surface, thereby identifying the point at which the object touched the surface. Other touch technologies useful in embodiments of the present invention may include dispersive signal technology and acoustic pulse recognition.

In the example of FIG. 1, the surface computer (152) renders display output on the surface (100) using a projector (102). The projector (102) renders a GUI on the surface (100) for viewing by the users. The projector (102) of FIG. 1 is implemented using Digital Light Processing (‘DLP’) technology originally developed at Texas Instruments. Other technologies useful in implementing the projector (102) may include liquid crystal display (‘LCD’) technology and liquid crystal on silicon (‘LCOS’) technology. Although the exemplary surface computer (152) of FIG. 1 above displays output on the surface (100) using a projector (102), readers will note that such an implementation is for explanation and not for limitation. In fact, other embodiments of a surface computer for displaying documents to a plurality of users according to embodiments of the present invention may use other technologies as will occur to those of skill in the art such as, for example, embedding a flat panel display into the surface (100).

The surface computer (152) of FIG. 1 includes one or more computer processors (156) as well as random access memory (‘RAM’) (168). The processors (156) are connected to other components of the system through a front side bus (162) and bus adapter (158). The processors (156) are connected to RAM (168) through a high-speed memory bus (166) and to expansion components through an extension bus (168).

Stored in RAM (156) is a content display module (120), computer software that includes computer program instructions for displaying personalized documents to users of the surface computer (152) according to embodiments of the present invention. The content display module (120) operates generally for displaying personalized documents to users of the surface computer (152) according to embodiments of the present invention by: registering a plurality of users with the surface computer (152); assigning, to each registered user, a portion of the surface (100) for interaction between that registered user and the surface computer (152); selecting a user profile (130) for each registered user; creating, for each registered user from a content repository (132), personalized display content for that registered user in dependence upon the user profile selected for that registered user; and rendering the personalized display content for each registered user on that user's assigned portion of the surface (100). The content rendered on the surface (100) may include text, graphics, video, and so on. The personalized display contents for each user may be contained in a document such as, for example, a word processing document, an image file, a video file, slide show presentation file, XML-based document, and so on. Readers will note that in a preferred embodiment, the display surface (100) is sufficiently large to accommodate several individuals seated around the display surface such as, for example, when the surface computer serves as a conference table.

Each user profile (130) of FIG. 1 specifies characteristics or preferences for a user. The user profiles (130) may be implemented as XML-based documents, C++ objects, Java objects, or in any other manner as will occur to those of skill in the art. For example, consider the following exemplary XML-based user profile for an employee in a company:

<user_profile id =“Maria”>

<department id = “Marketing”/>
<security_level id = “7”/>
...

</user_profile>

The exemplary user profile above specifies that a user identified as ‘Maria’ belongs to the marketing department and has a security level of ‘7.’ Using the exemplary user profile above, the content display module (120) may personalize content created from the content repository (132) for display to the user identified as ‘Maria.’ For example, the content display module (120) may select content from the content repository that specifically relates to the marketing department or that users having a security level of ‘7’ are authorized to view. Readers will note that the exemplary user profile above is for explanation and not for limitation. Other exemplary user profiles may include user modifiable profiles, user profiles based on an individual's role within an organization. Exemplary user profiles useful in some embodiments of the present invention may specify the size of the surface portion allocated to each user, for example, the moderator's user profile may specify that the moderator is assigned a larger portion of the surface than the user profiles for the other users of the surface table. For users not having a user profile, the surface computer may select a default or generic user profile.

In some embodiments, the surface computer may personalize a document across multiple users of the surface computer. To personalize a document across multiple users of the surface computer, the surface computer may combine the user profiles for the users designated to receive the personalized document to derive a common profile for the group. Using the common user profile for the group, each of the users of the group receive the same personalized version of the document created using the characteristics and preferences among all the users in the group.

Although the exemplary system of FIG. 1 illustrates the user profiles (130) in RAM (168), readers will now that the surface computer (152) may retrieve the user profiles (130) from a portable computing device placed on the surface (100) such as, for example, the Personal Digital Assistant (‘PDA’) (112), mobile phone (114), or the laptop (116). In other embodiments, the surface computer may retrieve the user profiles (130) from a database accessible to the surface computer through a network (101). In still other embodiments, the user profiles (130) may be stored in data storage (170) of the surface computer (152).

The content repository (132) of FIG. 1 represents a data structure that stores content or specifies the location of content that may be used to create personalized display content. The content repository (132) of FIG. 1 may be implemented as a database, an XML-document, word processing document, spreadsheet, a video file, graphics file, a slide show presentation file, or any other repository of content as will occur to those of skill in the art. In some exemplary embodiments, the content repository (132) may be implemented as a document that is shared by one of the users. In such embodiments, the content repository (132) may be stored on a user's portable computing device and transferred to RAM (168) once the user places the computing device on the surface (100).

Also stored in RAM (168) is an operating system (154). Operating systems useful for applying displaying personalized documents to users of a surface computer according to embodiments of the present invention may include or be derived from UNIX™, Linux™, Microsoft Vista™, Microsoft XP™, AIX™, IBM's i5/OS™, and others as will occur to those of skill in the art. The operating system (154), the content display module (120), the user profiles (130), and the content repository (132) in the example of FIG. 1 are shown in RAM (168), but many components of such software typically are stored in non-volatile memory also, such as, for example, on a disk drive (170).

The surface computer (152) of FIG. 1 includes disk drive adapter (172) coupled through expansion bus (160) and bus adapter (158) to processor (156) and other components of the computing device (152). Disk drive adapter (172) connects non-volatile data storage to the computing device (152) in the form of disk drive (170). Disk drive adapters useful in computing devices for displaying personalized documents to users of a surface computer according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (‘EEPROM’ or ‘Flash’ memory), RAM drives, and so on, as will occur to those of skill in the art.

The example surface computer (152) of FIG. 1 includes one or more input/output (‘I/O’) adapters (178). I/O adapters implement user-oriented input/output through, for example, software drivers and computer hardware for controlling output to devices such as computer display screens or speakers (171), as well as user input from user input devices such as, for example, microphone (176) for collecting speech input. The example surface computer (152) of FIG. 1 also includes a Digital Light Processing adapter (209), which is an example of an I/O adapter specially designed for graphic output to a projector (180). Video adapter (209) is connected to processor (156) through a high speed video bus (164), bus adapter (158), and the front side bus (162), which is also a high speed bus.

The exemplary surface computer (152) of FIG. 1 includes video capture hardware (111) that converts image signals received from the infrared cameras (106) to digital video for further processing, including pattern recognition. The video capture hardware (111) of FIG. 1 may use any number of video codec, including for example codec described in the Moving Picture Experts Group (‘MPEG’) family of specifications, the H.264 standard, the Society of Motion Picture and Television Engineers' 421M standard, or any other video codec as will occur to those of skill in the art. Although the video capture hardware (111) of FIG. 1 is depicted separately from the infrared cameras (106), readers will note that in some embodiment the video capture hardware (111) may be incorporated into the cameras (106). In such embodiments, the infrared camera (106) may connect to the other components of the surface computer through a Universal Serial Bus (‘USB’) connection, FireWire connection, or any other data communications connection as will occur to those of skill in the art.

The exemplary surface computer (152) of FIG. 1 also includes an Inter-Integrated Circuit (‘I²C’) bus adapter (110). The I²C bus protocol is a serial computer bus protocol for connecting electronic components inside a computer that was first published in 1982 by Philips. I²C is a simple, low-bandwidth, short-distance protocol. Through the I²C bus adapter (110), the processors (156) control the infrared lamp (104). Although the exemplary surface computer (152) utilizes the I²C protocol, readers will note this is for explanation and not for limitation. The bus adapter (110) may be implemented using other technologies as will occur to those of ordinary skill in the art, including for example, technologies described in the Intelligent Platform Management Interface (‘IPMI’) specification, the System Management Bus (‘SMBus’) specification, the Joint Test Action Group (‘JTAG’) specification, and so on.

The exemplary surface computer (152) of FIG. 1 also includes a communications adapter (167) that couples the surface computer (152) for data communications with other computing devices through a data communications network (101). Such a data communication network (100) may be implemented with external buses such as a Universal Serial Bus (‘USB’), or as an Internet Protocol (‘IP’) network or an Ethernet™ network, for example, and in other ways as will occur to those of skill in the art. Communications adapters implement the hardware level of data communications through which one computer sends data communications to another computer, directly or through a data communications network. Examples of communications adapters useful for displaying personalized documents to users of a surface computer according to embodiments of the present invention include modems for wired dial-up communications, Ethernet (IEEE 802.3) adapters for wired data communications network communications and 802.11 adapters for wireless data communications network communications.

FIG. 1 illustrates several computing devices (112, 114, 116) connected to the surface computer (152) for data communications through a network (101). Data communication may be established when the PDA (112), the mobile phone (114), and the laptop (116) are placed on top of the surface (100). Through the images of the computing devices (112, 114, 116), the surface computer (152) may identify each device (112, 114, 116) and configure a wireless data communications connections with each device. Through the wireless data communications connections, the surface computer (152) may retrieve any documents contained in the devices (112, 114, 116) into the surface computer's memory and render the documents contents on the surface (100) for interaction with surface computer's users.

The arrangement of networks and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

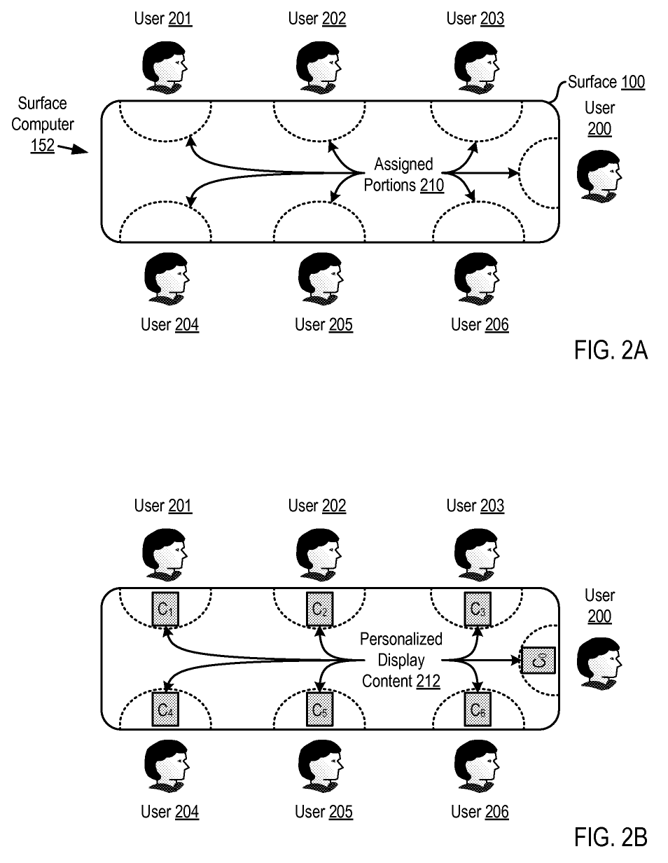

For further explanation, FIGS. 2A-B sets forth line drawings illustrating exemplary surfaces useful in displaying personalized documents to users of a surface computer according to embodiments of the present invention. The surface (100) of FIGS. 2A-B is comprised in a surface computer (152). The surface computer is capable of receiving multi-touch input through the surface (100) and rendering display output on the surface (100).

In the examples of FIGS. 2A-B, a plurality of users (200-206) are positioned adjacent to the surface computer (152) for interaction through the surface (100). Each user (200-206) may choose their respective position around the surface computer (152) by choosing a chair in which to sit around the surface computer (152) or by merely standing near an edge of the surface (100). After the users (200-206) choose a location near the surface (100), the surface computer (152) registers the users (200-206) with the surface computer (152) and assigns a portion (210) of the surface (100) to each registered user (200-206) for interaction between that registered user (200-206) and the surface computer (152). Registering the users (200-206) with the surface computer (152) and assigning a portion (210) of the surface (100) to each registered user (200-206) is discussed in more detail below.

In FIG. 2B, the surface computer (152) selects a user profile for each registered user and creates, for each registered user from a content repository, personalized display content (212) for that registered user in dependence upon the user profile selected for that registered user. If the content repository is a document, the surface computer may create the personalized display content for each user by modifying the document according to the user's profile. The surface computer (152) then renders the personalized display content (212) for each registered user on that user's assigned portion of the surface. In the example of FIG. 2B, the personalized display content (212) created for user (200) is depicted as ‘C₀.’ The personalized display content (212) created for user (201) is depicted as ‘C₁.’ The personalized display content (212) created for user (202) is illustrated in FIG. 2B as ‘C₂.’ The personalized display content (212) created for user (202) is illustrated in FIG. 2B as ‘C₂.’ The personalized display content (212) created for user (203) is illustrated in FIG. 2B as ‘C₃.’ The personalized display content (212) created for user (204) is illustrated in FIG. 2B as ‘C₄.’ The personalized display content (212) created for user (205) is illustrated in FIG. 2B as ‘C₅.’ The personalized display content (212) created for user (206) is illustrated in FIG. 2B as ‘C₆.’

As mentioned above, in some embodiments, the content repository from which the personalized display content (212) is derived may be a document shared by one of the users (200-206). In such an embodiment, the document may initially be stored in the user's portable computing device and placed by the user on the surface (100) of the surface computer (152). Upon detecting that the computing device is placed on the surface (100) of the surface computer (152), the surface computer (152) may establish a data communications connection with the portable computing device and retrieve the document from the computing device. Upon receiving an instruction from the user, the surface computer (152) may render the contents of the shared document on the portion of the surface (100) assigned to the user sharing the document. The surface computer (152) may then select a user profile for each registered user and create, for each registered user from the shared document, personalized display content for that registered user in dependence upon the user profile selected for that registered user.

After the user sharing the document is finished sharing the document with the other users, the user sharing the document may instruct the surface computer (152) to stop sharing the document. The surface computer (152) of FIG. 2B therefore may receive an instruction from the user sharing the document to terminate the document sharing. In response to receiving the user's instruction to terminate sharing of the document, the surface computer (152) may remove the shared document contents from each of the participants' portions of the surface (100). In some embodiments, the surface computer (152) may allow the users (200-206) to augment their personalized display contents with additional information such as, for example, meeting notes, which may be input through the surface (100). The surface computer may provide a dedicated area of the user's assigned portion of the surface to receive this additional information. In other embodiments, the surface computer may provide an input region to receive this additional information that overlays the personalized display content on the user's assigned surface portion. The surface computer may allow the user to save the additional information in a document along with or separate from the personalized display content depending on the user's profile, Digital Rights Management (‘DRM’) setting for the display content repository, or any other criteria as will occur to those of skill in the art.

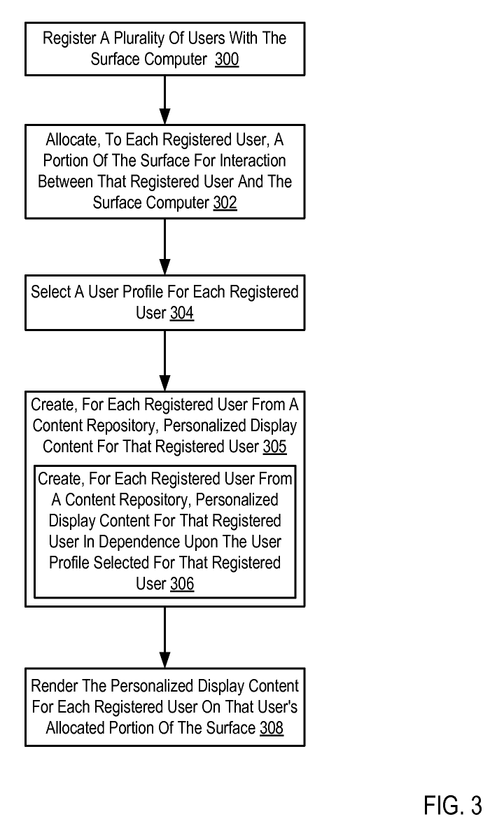

For further explanation, FIG. 3 sets forth a flow chart illustrating an exemplary method of displaying personalized documents to users of a surface computer according to embodiments of the present invention. The surface computer includes a surface and is capable of receiving multi-touch input through the surface and rendering display output on the surface. In such a manner, the surface provides an intuitive and efficient mechanism for users to interact with the surface computer.

The method of FIG. 3 includes registering (300) a plurality of users with the surface computer. The plurality of users includes a moderator and a plurality of participants. The moderator is a user of the surface computer who shares a document with other users of the surface computer referred to as the participants. Registering (300) a plurality of users with the surface computer according to the method of FIG. 3 may be carried out by authenticating the identity of a user through the user's interaction with the surface computer and determining the user's authorization for using the surface computer. The authentication process may be carried out in variety of ways as will occur to those of skill in the art. For example, the surface computer may render a list of authorized users on the surface to allow the requesting user to select their name from the list. Upon selecting their name, the user may provide a password or other security tokens used for authentication. Consider another example, in which the users are all part of the same team in a company and are using the surface computer to conduct a team meeting. In such an example, the authentication process may be carried out by placing the user's company RFID badge on the surface so that the surface computer may identify the user by comparing security data retrieved from the user's company RFID badge with security data for the user stored in the company's employee database. Still further, other examples of authenticating a user may include the use of biometric authentication such as, for example, voice prints, retinal scans, or fingerprint matching, or the use of public-private key infrastructures.

After authenticating the user, the surface computer may determine the user's authorization for using the surface computer by retrieving access permissions for the authenticated user from the surface computer's authorization policy. The granularity of the access permissions may vary from one embodiment to another. For example, an authorization policy may provide either complete access to the surface computer or no access to the surface computer at all depending on the user's identity. In other embodiments, an authorization policy may provide access to view documents using the surface computer, but no authorization to add, modify, or delete documents. Readers will note that the authorization policy may not assign access permission directly to individual users. Rather, the authorization policy may assign access permissions to a group to which an individual user belongs.

The method of FIG. 3 also includes assigning (302), to each registered user, a portion of the surface for interaction between that registered user and the surface computer. Assigning (302), to each registered user, a portion of the surface for interaction between that registered user and the surface computer according to the method of FIG. 3 may be carried out by identifying a point on the surface that is adjacent to that registered user and defining a region around that identified point for use by that registered user to interact with the surface computer. The surface computer may identify a point on the surface that is adjacent to a registered user by instructing a user to touch the surface directly in front of that user and detecting the location of the user's touch though any number of multi-touch detection technologies such as, for example, surface image processing or frustrated total internal reflection. Other techniques for identifying a point on the surface that is adjacent to a registered user may include assigning a point on the surface that is adjacent to a registered user by detecting the user's position relative to the table through location triangulation using a set of microphones that capture the user's speech or proximity sensors.

The surface computer may define a region around that identified point by establishing a boundary around the identified point that extends from the edge of the surface toward the center of the surface. Combined with the edge of the surface, the boundary may resemble a rectangle, a semicircle, a triangle, or any other geometric shape. In some embodiments, the surface computer may render a line along the boundary of the region to aid the users in visualizing their portions of the surface through which they may interact with the surface computer. Once defined, the boundary used to define the region may be fixed or movable by the user. The user may move the boundary by manipulating the lines rendered on the surface using the user's fingers. For example, if the user wants a larger portion of the surface with which to interact with the surface computer, then the user may drag the boundary line defining the user's portion of the surface away from the user. The surface computer may detect the user's input, recognize the input as an adjustment to the user's boundary, reassign the surface portion to the user based on the boundary adjustment input, and redraw the boundary line at the edge of the user's assigned portion of the surface.

Readers will note that assigning (302), to each registered user, a portion of the surface for interaction between that registered user and the surface computer as described above is carried out using input from the users of the surface computer. In some other embodiments, however, assigning (302), to each registered user, a portion of the surface for interaction between that registered user and the surface computer may be carried out without any user intervention at all. The surface computer may assign a portion of the surface to each user based on user preferences provided in the user's profile such as, for example, the user's preferred location around the surface. In other embodiments, a moderator may provide the surface computer with assignment instructions for each of the users around the surface. Readers will note that the surface computer may adjust the size of each user's assigned portion based on the surface size, the number of users sitting around the surface, and so on.

The method of FIG. 3 also includes selecting (304) a user profile for each registered user. As mentioned above, a user profile specifies characteristics or preferences for a user. The user profile may apply to a user individually or to a set of users collectively in a group. The manner in which the user profile is selected may vary from one embodiment to another. Selecting (304) a user profile for each registered user according to the method of FIG. 3 may be carried out by retrieving the user profile for that user from that user's portable computing device when the device is place on the surface of the surface computer. Selecting (304) a user profile for each registered user according to the method of FIG. 3 may be carried out by retrieving the user profile for that user from a database accessible to the surface computer through a network using an identifier for the user provided when the surface computer registered the user. Similarly, selecting (304) a user profile for each registered user according to the method of FIG. 3 may be carried out by retrieving the user profile from data storage of the surface computer using an identifier for the user provided when the surface computer registered the user. In such embodiments, the user profile for each user has previously been configured. In embodiments where the user does not have an individual user profile, selecting (304) a user profile for each registered user according to the method of FIG. 3 may be carried out by retrieving a generic user profile or a user profile assigned to a group to which the user belongs. In still other embodiments, selecting (304) a user profile for each registered user according to the method of FIG. 3 may be carried out by displaying a list of user profile templates to that users and receiving that user's selection of a particular user profile template for use as the user's user profile while displaying personalized documents to users of a surface computer according to embodiments of the present invention.

The method of FIG. 3 includes creating (306), for each registered user from a content repository, personalized display content for that registered user in dependence upon the user profile selected for that registered user. As mentioned above, a content repository is a data structure that stores content or specifies the location of content that may be used to create personalized display content. A content repository may be implemented as a database, an XML-document, word processing document, spreadsheet, a video file, graphics file, a slide show presentation file, or any other repository of content as will occur to those of skill in the art. Using the content contained in any of these exemplary content repositories, a surface computer may create personalized display content for each registered user.

Creating (306), for each registered user from a content repository, personalized display content for that registered user according to the method of FIG. 3 may be carried out by filtering repository content of the content repository in dependence upon the user profile selected for that registered user and filtering rules. Filtering rules specify portions of content in the content repository for display to a user based on the user's user profile. Consider, for example, the following exemplary filtering rules:

<filtering_rules>

<rule id = “1”>

<match>

<user_profile>department</user_profile>
<content_repository>department</content_repository>

</match>

</rule>
<rule id = “2”>

<less_than_equal_to>

<content_repository>

security_level

</content_repository>
<user_profile>security_level</user_profile>

</less_than_equal_to>

</rule>
...

</filtering_rules>

The exemplary filtering rules above illustrate two filtering rules that specify the portions of content in a content repository for display to a user based on the user's user profile. The first rule has an identifier of ‘1’ and specifies that the surface computer may display the portion of content tagged with a ‘department’ tag in the content repository that has the same value as the value for the ‘department’ tag in the user profile for that user. For example, the content in the content repository tagged with a ‘department’ tag having a value of ‘Marketing’ may be displayed to a user whose user profile specifies that the user belongs to the ‘Marketing’ department. The second rule has an identifier of ‘2’ and specifies that the surface computer may display the portion of content in the content repository tagged with a ‘security_level’ tag that has a value less than or equal to the value for the ‘security_level’ tag in the user profile for that user. For example, the surface computer may display to a user having a security level of ‘7’ the content in the content repository tagged with a ‘security_level’ tag having a value of ‘7,’ ‘8,’ ‘9,’ and so on. Readers will note that the exemplary filtering rules above and their implementation in XML are for explanation only and not for limitation. Filtering rules useful in displaying personalized documents to users of a surface computer according to embodiments of the present invention may be implemented using, for example, XML, C++, Java, Perl, or using any implementation as will occur to those of ordinary skill in the art. In some embodiments of the present invention, transformation rules may also be used to eliminate the need to tag the content in the display content repository. Consider, for example, that the display content repository contains content created for the engineering department of a company. The surface computer may use the transformation rules to reduce the complexity of the content in the repository for a user that is a member of the company's marketing department.

Creating (306), for each registered user from a content repository, personalized display content for that registered user according to the method of FIG. 3 may also be carried out by dynamically generating at least a portion of the personalized display content in dependence upon the user profile selected for that registered user and dynamic content generation rules. Dynamic content generation rules specify content dynamically aggregated together for display to a user based on the user's user profile. Consider, for example, the following exemplary dynamic content generation rules:

<dynamic_content_generation_rules>

<rule id = “1”>

<retrieve>

http://internalnews.company.com/retrieve?dept=
<<user_profile>department</user_profile>>

</retrieve>

</rule>
...

</dynamic_content_generation_rules>

The exemplary dynamic content generation rules illustrate one rule that specifies content dynamically aggregated together for display to a user based on the user's user profile. The rule has an identifier of ‘1’ and specifies a ‘retrieve’ script for dynamically aggregating internal company news for the user's department for display to the user. The ‘retrieve’ script is located at ‘internalnews.company.com’ and invoked with the parameter ‘dept’ having the value of the user's department as specified in the user profile for the user. Readers will note that the exemplary dynamic content generation rules above and their implementation in XML are for explanation only and not for limitation. Dynamic content generation rules useful in displaying personalized documents to users of a surface computer according to embodiments of the present invention may be implemented using, for example, XML, C++, Java, Perl, or using any implementation as will occur to those of ordinary skill in the art.

As mentioned above, in some embodiments, the content repository may be implemented as a document shared by one of the users to the other users. In such embodiments, creating (306), for each registered user from a content repository, personalized display content for that registered user according to the method of FIG. 3 may be carried out by creating the personalized display content for that registered user from the shared document using filtering rules or dynamic content generation rules as described above. The shared document may initially be stored in the user's portable computing device and placed by the user on the surface of the surface computer. Upon detecting that the computing device is placed on the surface of the surface computer, the surface computer may establish a data communications connection with the portable computing device and retrieve the document from the computing device.

The method of FIG. 3 includes rendering (308) the personalized display content for each registered user on that user's assigned portion of the surface. Rendering (308) the personalized display content for each registered user on that user's assigned portion of the surface according to the method of FIG. 3 may be carried out by orienting the personalized display contents for each user such that the top of the contents is directed toward the center of the surface and displaying the personalized display contents on that user's assigned portion of the surface.

For further explanation, consider the following exemplary use case for displaying personalized documents to users of a surface computer according to embodiments of the present invention. In this exemplary use case, a surface computer functions as a restaurant table, the users are customers at the restaurant, and the content repository is implemented as a restaurant menu. The restaurant menu may include the following exemplary items:
Hamburger
Cheese Burger
French Fries
Garden Salad
Chocolate Cake
Milk Shake

As the customers sit down at the surface computer, the surface computer registers each customer and assigns, to each registered customer, a portion of the surface for interaction between that registered user and the surface computer. In some cases, the registration process may simply involve prompting each customer for their name. In other cases, the registration process may be more involved and include obtaining payment information, dining preferences, and so on.

The surface computer may then select a user profile for each registered customer. The user profile may be created for the customer as part of the registration process or retrieved from the restaurant's database when the customer is a returning patron. In some cases, the user profile may be retrieved from a third-party provider that may have already collected profile data for the customer. When the user profile is created as part of the registration process, the customer may specify detailed information concerning the user's dining preferences such as, for example, the types of spices the customer enjoys, whether the customer prefers lemon or lime in their drinks, the types of meat that the customer prefers, and so on. In other embodiments, the customer may select from more general user profiles that encompass a pre-defined set of users such as, for example, a lactose-free user profile, a vegetarian user profile, and so on.

After selecting a user profile for each registered customer, the surface computer creates, for each registered user from the restaurant menu, personalized display content for that registered customer in dependence upon the user profile selected for that registered customer and renders the personalized display content for each registered user on that user's assigned portion of the surface. In this exemplary use case, the surface computer may create personalized display content for each registered user from the restaurant menu by creating a personalized menu in dependence upon dietary preferences contained in the user profile selected for that registered user. For example, consider a user having a user profile containing dietary preferences indicating that the user is lactose intolerant. The surface computer may create and render the following exemplary personalized menu in that user's assigned portion of the surface:
Hamburger
French Fries
Garden Salad
Chocolate Cake

For other example, consider a user having a user profile containing dietary preferences indicating that the user is a vegetarian. The surface computer may create and render the following exemplary personalized menu in that user's assigned portion of the surface:
French Fries
Garden Salad
Chocolate Cake
Milk Shake

For another example, consider a user having a user profile containing dietary preferences indicating that the user is on a diet. The surface computer may create and render the following exemplary personalized menu in that user's assigned portion of the surface:
Garden Salad

Readers will note that the exemplary menus and the exemplary use case described above are for explanation and not for limitation.

Exemplary embodiments of the present invention are described largely in the context of a fully functional computer system for displaying personalized documents to users of a surface computer. Readers of skill in the art will recognize, however, that the present invention also may be embodied in a computer program product disposed on a computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of displaying personalized documents to users of a surface computer, the surface computer comprising a surface, surface computer capable receiving multi-touch input through the surface and rendering display output on the surface, the method comprising:
registering a plurality of users with the surface computer;
assigning, to each registered user, a portion of the surface for interaction between that registered user and the surface computer;
selecting a user profile for each registered user;
creating, for each registered user from a content repository, personalized display content for that registered user in dependence upon the user profile selected for that registered user; and
rendering the personalized display content for each registered user on that user's assigned portion of the surface.

2. The method of claim 1 wherein creating, for each registered user from a content repository, personalized display content for that registered user in dependence upon the user profile selected for that registered user further comprises filtering repository content of the content repository in dependence upon the user profile selected for that registered user and filtering rules.

3. The method of claim 1 wherein creating, for each registered user from a content repository, personalized display content for that registered user in dependence upon the user profile selected for that registered user further comprises dynamically generating at least a portion of the personalized display content in dependence upon the user profile selected for that registered user and dynamic content generation rules.

4. The method of claim 1 wherein:
the content repository is a document shared by one of the plurality of users; and
creating, for each registered user from a content repository, personalized display content for that registered user in dependence upon the user profile selected for that registered user further comprises creating the personalized display content for that registered user from the shared document.

5. The method of claim 1 wherein:
the surface computer functions as a restaurant table;
the content repository is a restaurant menu; and
creating, for each registered user from a content repository, personalized display content for that registered user in dependence upon the user profile selected for that registered user further comprises creating a personalized menu in dependence upon dietary preferences contained in the user profile selected for that registered user.

6. The method of claim 1 wherein the user profile is retrieved from a portable computing device placed on the surface.

7. The method of claim 1 wherein the user profile is retrieved from a database accessible to the surface computer through a network.

8. The method of claim 1 wherein the user profile is stored in data storage of the surface computer.

9. A surface computer for displaying personalized documents to users of a surface computer, the surface computer comprising a surface, surface computer capable of receiving multi-touch input through the surface and rendering display output on the surface, the surface computer comprising a computer processor, a computer memory operatively coupled to the computer processor, the computer memory having disposed within it computer program instructions capable of:
registering a plurality of users with the surface computer;
assigning, to each registered user, a portion of the surface for interaction between that registered user and the surface computer;
selecting a user profile for each registered user;
creating, for each registered user from a content repository, personalized display content for that registered user in dependence upon the user profile selected for that registered user; and
rendering the personalized display content for each registered user on that user's assigned portion of the surface.

10. The surface computer of claim 9 wherein creating, for each registered user from a content repository, personalized display content for that registered user in dependence upon the user profile selected for that registered user further comprises filtering repository content of the content repository in dependence upon the user profile selected for that registered user and filtering rules.

11. The surface computer of claim 9 wherein creating, for each registered user from a content repository, personalized display content for that registered user in dependence upon the user profile selected for that registered user further comprises dynamically generating at least a portion of the personalized display content in dependence upon the user profile selected for that registered user and dynamic content generation rules.

12. The surface computer of claim 9 wherein:
the content repository is a document shared by one of the plurality of users; and
creating, for each registered user from a content repository, personalized display content for that registered user in dependence upon the user profile selected for that registered user further comprises creating the personalized display content for that registered user from the shared document.

13. The surface computer of claim 9 wherein:
the surface computer functions as a restaurant table;
the content repository is a restaurant menu; and
creating, for each registered user from a content repository, personalized display content for that registered user in dependence upon the user profile selected for that registered user further comprises creating a personalized menu in dependence upon dietary preferences contained in the user profile selected for that registered user.

14. A computer program product for displaying personalized documents to users of a surface computer, the surface computer comprising a surface, surface computer capable of receiving multi-touch input through the surface and rendering display output on the surface, the computer program product disposed in a computer readable medium, the computer program product comprising computer program instructions capable of:
registering a plurality of users with the surface computer;
assigning, to each registered user, a portion of the surface for interaction between that registered user and the surface computer;
selecting a user profile for each registered user;
creating, for each registered user from a content repository, personalized display content for that registered user in dependence upon the user profile selected for that registered user; and
rendering the personalized display content for each registered user on that user's assigned portion of the surface.

15. The computer program product of claim 14 wherein creating, for each registered user from a content repository, personalized display content for that registered user in dependence upon the user profile selected for that registered user further comprises filtering repository content of the content repository in dependence upon the user profile selected for that registered user and filtering rules.

16. The computer program product of claim 14 wherein creating, for each registered user from a content repository, personalized display content for that registered user in dependence upon the user profile selected for that registered user further comprises dynamically generating at least a portion of the personalized display content in dependence upon the user profile selected for that registered user and dynamic content generation rules.

17. The computer program product of claim 14 wherein:
the content repository is a document shared by one of the plurality of users; and
creating, for each registered user from a content repository, personalized display content for that registered user in dependence upon the user profile selected for that registered user further comprises creating the personalized display content for that registered user from the shared document.

18. The computer program product of claim 14 wherein:
the surface computer functions as a restaurant table;
the content repository is a restaurant menu; and
creating, for each registered user from a content repository, personalized display content for that registered user in dependence upon the user profile selected for that registered user further comprises creating a personalized menu in dependence upon dietary preferences contained in the user profile selected for that registered user.

19. The computer program product of claim 14 wherein the computer readable medium comprises a recordable medium.

20. The computer program product of claim 14 wherein the computer readable medium comprises a transmission medium.
